(19) United States
(12) Patent Application Publication
(10) Pub. No.: US 2014/0056795 A1
(43) Pub. Date: Feb. 27, 2014

(54) PROCESS FOR MANUFACTURING HIGH DENSITY BORON CARBIDE

(71) Applicant: Rafael-Armament Development Authority Ltd., Haifa (IL)

(72) Inventors: Shimshon Bar-ziv, Misgav (IL); Yehoshua Hachamo, Nahariya (IL); David Gorni, Michmoret (IL); Zohar Ophir, Haifa (IL); Itamar Gutman, Kiryat Bialik (IL); Joseph Frey, Haifa (IL); Zvi Nisenholz, Misgav (IL)

(73) Assignee: Rafael-Armament Development Authority Ltd., Haifa (IL)

(21) Appl. No.: 14/070,205

(22) Filed: Nov. 1, 2013

Related U.S. Application Data
(63) Continuation-in-part of application No. 13/346,294, filed on Jan. 9, 2012, now abandoned.
Application No. 13/346,294 is a continuation of application No. 11/630,711, filed on Dec. 18, 2007, now Pat. No. 8,110,165.

(30) Foreign Application Priority Data
Jun. 22, 2004 (IL) 162676

(51) Int. Cl. C01B 31/36

(52) U.S. Cl. CPC C01B 31/36
USPC 423/291; 264/29.6

(57) ABSTRACT

The invention provides a process for manufacturing high density boron carbide by pressureless sintering, enabling to create sintered products of complex shapes and high strength. The robust process of the invention enables to employ low-cost raw powders.

### CROSS-REFERENCE TO RELATED APPLICATIONS

This application is a continuation-in-part application of U.S. patent application Ser. No. 13/346,294, filed on Jan. 9, 2012, which is a continuation application of U.S. patent application Ser. No. 11/630,711, now U.S. Pat. No. 8,110,165, filed on Dec. 18, 2007, which is the National Stage of International Application No. PCT/IL2005/000645, filed on Jun. 17, 2005, which claims priority to Israel Patent Application No. 162676, filed on Jun. 22, 2004, all of which are incorporated herein in their entirety by reference thereto.

### FIELD OF THE INVENTION

The present invention relates to a process for manufacturing high density boron carbide by pressureless high temperature sintering.

### BACKGROUND OF THE INVENTION

The fast growing demand for extremely hard materials results from their numerous applications. Boron carbide, a typical representative of such materials, can be used in armor plates, and as an abrasion resisting material. Most applications of boron carbide require that its density be as high as possible—in other words, the density should be close to the theoretical density (TD). The manufacturing of high density boron carbide is a multistage process, whose final stage is sintering which can be conducted under high pressure or without applying a pressure. Pressureless sintering of materials is more advantageous compared to hot pressing with respect to process cost and ability to organize it in a continuous mode. In the case of a batch mode, pressureless sintering permits a larger scale production.

The common practice to achieve high density of materials (more than 90% TD) is a use of sintering additives. In the case of boron carbide, carbon is used as a sintering aid. The source of carbon may be amorphous carbon (in a form of carbon black, for example) or carbon precursors. In both cases, the boron carbide powder is blended with an additive, then press compacted and sintered. If a carbon precursor is used as an additive, the compacted “green” body should be further heat-treated by pyrolysis or carbonization (prior to sintering) in order to transform the precursor to carbon.

U.S. Pat. No. 4,195,066 discloses a process which requires very fine raw boron carbide powder (grain size<1 μm, specific area 10-50 m²/g) and uses additives in the form of amorphous carbon as well as organic carbon precursor. Fine boron carbide powder, exhibiting high specific area, is extremely expensive, therefore the application of the said process is limited.

The process disclosed in GB 2,014,193 requires a sub-micron (0.1 μm) boron carbide powder and uses glucose as a carbon precursor.

U.S. Pat. No. 5,720,911 describes a method of making a boron carbide article by sintering which includes mixing boron carbide with an epoxidized resin in solution, drying to form a granulated homogenized mixture, and carbonizing by maintaining the mixture at least two constant temperatures for predetermined times.

U.S. Pat. No. 5,505,899 refers to a process for producing shaped bodies of boron carbide, comprising homogeneously mixing pulverulent boron carbide with at least one pulverulent monocarbide of Ti, Zr, Hf, V, Nb and Ta, sintering at temperatures from 2100° C. to 2250° C., and further densifying by hot isostatic pressing.

JP 07169190 describes a process comprising preparation of a carbon precursor powder from calcined coke, its further drying and mixing with boron-carbide powder, cold isostatic pressing and further carbonization at a temperature less than 2200° C. in a non-oxidizing atmosphere.

The art is always looking for improved processes which may lead to increased density of the final product and which permit to create more complex and stronger shapes of the final product, without sensitive dependence on the raw material quality. It is an object of the invention to provide a robust process yielding higher density products, while utilizing a pressureless sintering and thus avoiding expensive hot pressing procedures, and while depending less on the raw material quality.

It is another object of the invention to provide an improved process for manufacturing high density boron carbide (about 96% TD) by pressureless high temperature sintering.

It is yet another object of the invention to provide an efficient process that permits to create more complex and stronger shapes of the sintered product.

It is still another object of the invention to provide a robust process yielding higher density boron carbide sintered products, doing without fine raw boron carbide powders, while utilizing low-cost raw powders of boron carbide having a BET surface area as low as 5 m²/g or less.

Other objects and advantages of the invention will become apparent as the description proceeds.

### SUMMARY OF THE INVENTION

The invention provides a process for manufacturing boron carbide objects comprising the steps of: (a) pre-washing a raw boron carbide powder with an organic solvent selected from the group consisting of isopropyl alcohol, ethyl alcohol, methyl alcohol, acetone, and a combination thereof, said pre-washing including stirring a mixture comprising said powder with said solvent for about 24 hours, followed by removing a substantial part of said solvent from said mixture; (b) mixing a boron carbide powder with a carbon precursor selected from the group consisting of phenolic resin, aqueous solution of a polysaccharide, and mixture of two or more saccharides; (c) drying and granulating a boron carbide, pre-washed and mixed with a carbon precursor according to steps (a) and (b); (d) compacting the granulated dried mixture of step (c) to form a shaped object by applying a pressure thereto; (e) carbonizing the shaped body in an inert atmosphere, by dwelling at a high temperature for a predetermined period of time; and (f) sintering the carbonized shaped body at a temperature between about 2300° C. and about 2350° C. in an inert atmosphere for a time period of, preferably, not less than about 20 min. In one embodiment of the invention, said steps (a) and (b) are carried out simultaneously. Said carbon precursor which is mixed with the boron carbide powder may include a phenolic resin. Said drying may be carried out by spray drying. In one embodiment of the process according to the invention, the pressure is applied uniaxially. In other embodiment, the pressure is applied isostatically. In a preferred embodiment, the compacting is carried out with heating, for example at a temperature of between about 130° C. and about 170° C. Preferably, the compaction is carried out until the density of the compacted shaped body reaches a value of at least 1.36 g/cc. The carbonization step is preferably carried out in a nitrogen atmosphere or in an argon atmosphere. The sintering is preferably carried out in an argon atmosphere. In a preferred embodiment of the process according to the invention, the sintering is performed while the shaped body is constrained between shaped graphite dies having essentially a geometry to match a desired final geometry of said shaped body. Said graphite dies may have a non-flat, multi-curved shape.

The invention is directed to a robust process for manufacturing boron carbide objects of superior anti-ballistic performance from a low grade boron carbide powder, employing pressureless sintering, comprising (a) providing a low grade raw boron carbide powder having a BET surface area as low as 2 m²/g, for example 1.9 m²/g, or D₅₀ value as high as 5 μm; (b) pre-washing said low grade powder with an organic solvent selected from the group consisting of isopropyl alcohol, ethyl alcohol, methyl alcohol, acetone, and a combination thereof, said pre-washing including stifling a mixture comprising said powder with said solvent for about 24 hours, followed by removing a substantial part of said solvent from said mixture; (c) mixing said low grade powder, either after pre-washing of step (b) or simultaneously therewith, with a carbon precursor selected from the group consisting of phenolic resin, aqueous solution of a polysaccharide, and mixture of two or more saccharides; (d) drying and granulating a boron carbide, pre-washed and mixed with a carbon precursor according to steps (b) and (c);
(e) compacting the granulated dried mixture of step (d) to form a shaped object by applying a pressure thereto; (f) carbonizing the shaped body in an inert atmosphere, by dwelling at a high temperature for a predetermined period of time; and (g) sintering the carbonized shaped body at a temperature between about 2300° C. and about 2350° C. in an inert atmosphere for a time period of not less than about 20 min, preferably between 20 and 240 minutes.

In a preferred embodiment of the invention, provided is a robust process for manufacturing boron carbide objects of superior anti-ballistic performance from a low grade boron carbide powder by employing pressureless sintering, the process consisting of the following steps: (a) providing a low grade raw boron carbide powder having a BET surface area as low as about 2 m²/g or less; (b) pre-washing said low grade powder with isopropyl alcohol (IPA), said pre-washing including stirring a mixture at least 0.66 kg of IPA per 1 kg of said powder for about 24 hours, for example between 0.66 and 1 kg IPA per 1 kg powder; (c) mixing said low grade powder, either after pre-washing of step b or simultaneously therewith, with a carbon precursor comprising phenolic resin in an amount of about 0.15 to about 0.18 kg per 1 kg of said powder, for example 18 kg resin per 100 kg of said low grade powder; (d) drying and granulating a boron carbide, pre-washed and mixed with said carbon precursor according to steps b and c; (e) compacting the granulated dried mixture of step d to form a shaped object by applying a pressure thereto; (f) carbonizing the shaped body in an inert atmosphere, by dwelling at a temperature between about 500° C. and about 1000° C. for a predetermined period of time, for example several hours; and (g) sintering the carbonized shaped body at a temperature between 2300° C. and 2350° C. in an argon atmosphere for a time period of between 30 and 60 min.

The invention provides shaped, high-density boron carbide antiballistic objects made by a process for manufacturing boron carbide objects comprising the steps of: (a) pre-washing a raw boron carbide powder with an organic solvent selected from the group consisting of isopropyl alcohol, ethyl alcohol, methyl alcohol, acetone, and a combination thereof, said pre-washing including stirring a mixture comprising said powder with said solvent for about 24 hours, followed by removing a substantial part of said solvent from said mixture; (b) mixing a boron carbide powder with a carbon precursor selected from the group consisting of phenolic resin, aqueous solution of a polysaccharide, and mixture of two or more saccharides; (c) drying and granulating a boron carbide, pre-washed and mixed with a carbon precursor according to steps (a) and (b); (d) compacting the granulated dried mixture of step (c) to form a shaped object by applying a pressure thereto; (e) carbonizing the shaped body in an inert atmosphere, by dwelling at a high temperature for a predetermined period of time; and (f) sintering the carbonized shaped body at a temperature between about 2300° C. and about 2350° C. in an inert atmosphere for a time period of, preferably, not less than about 20 min.

In a preferred embodiment, the process of the invention comprises the steps of:
(a) pre-washing the raw ceramic powder with an organic solvent, preferably with alcohol solvent, preferably with isopropyl alcohol (IPA), said pre-washing including prolonged mixing with the solvent followed by removing a substantial part of the solvent;
(b) mixing the boron carbide powder with a carbon precursor, either after said pre-washing or simultaneously with it, preferably with phenolic resin or with an aqueous solution of a polysaccharide;
(c) drying the mixture;
(d) granulating the dried mixture;
(e) compacting the granulated powder blend (to form the desired shape—flat or curved) by uniaxial pressing carried out at a temperature between room temperature and about 170° C., preferably at a temperature higher than 130° C.;
(f) carbonizing the compacted green object in an inert atmosphere, preferably in a nitrogen or argon atmosphere, by dwelling at high temperature for a predetermined time and controlling the heating rate; and
(g) sintering at a temperature range of about 2300° C. to about 2350° C. in an inert atmosphere, preferably in argon, for a time period between 20 and 120 minutes.

### DETAILED DESCRIPTION OF THE INVENTION

The main stages of the process are briefly described below:

### Raw Material of Boron Carbide

Boron carbide of relatively lower BET surface may be advantageously employed in the process. It is one of the advantages that a relatively cheap boron carbide may be employed. For example, the particles may have D₅₀ of more than 2 μm, or the particles may have D₅₀ of more than 3 μm, or the particles may have D₅₀ of more than 4 μm such as for example about 5 μm. For example, in one embodiment D₅₀ is about 5 μm or less, D₉₀ is about 10 μm or less, and particles larger than 25 μm are preferably disallowed. BET surface area of the particles may be as low as 5 m²/g or lower, preferably as low as 4 m²/g or lower, for example as low as 3 m²/g or lower ; BET surface area of the particles may be for example as low as about 2 m²/g or lower. In one embodiment, the BET surface area of the particles may be as low as about 5 m²/g. In other embodiment, the BET surface area of the particles may be as low as about 4 m²/g. In other embodiment, the BET surface area of the particles may be as low as about 3 m²/g. In other embodiment, the BET surface area of the particles may be as low as about 2 m²/g, for example about 2.2 m²/g or even as low as about 1.9 m²/g. The B₄C content may be 99.5% or less, for example 99.0% or less, for example 98.0% or less, such as 97% or 96.5%. Preferably, the B4C content is at least 96.5%, more preferably at least 97%.

### Pre-Washing of the Powder

Boron carbide powder is mixed with a polar solvent like alcohol, preferably IPA (for example, technical grade) in the ratio of between about 0.75 Kg and about 1.2 kg boron carbide powder per liter IPA. The mixing is conducted for at least 10 hours, usually 24 hours. Different mixing devices can be used—ball mills, mechanical stirrers, blade mixers, etc. Following the mixing the blend is dried at an elevated temperature, such as between 50 and 80° C., possibly using vacuum. For example, approximately between 65 and 75° C., such as about 70° C. for 24 hours is employed, or 54° C. is employed with vacuum of about 25 mm Hg for about 12 hours, preferably until IPA concentration is less than 4%, more preferably less than 1% (mass). The drying chamber is equipped with an exhaust pipe to let the IPA vapors out. The term “pre-washing” as used throughout this specification is directed to a procedure step including mixing boron carbide powder before sintering with a polar organic solvent, preferably lower alcohol or acetone, more preferably alcohol, followed by removing a substantial part of the solvent by evaporation at an elevated temperature. Surprisingly, the pre-washing step improves the properties of the final sintered body. Without committing themselves to any particular theory, the inventors believe that certain impurities present in the raw material are converted to a volatile form (possibly enabled by autocatalytic effects of materials present in raw boron carbide) and removed with gases during said step of pre-washing, particularly during the drying stage at higher temperature.

### Mixing, Drying and Granulating

Boron carbide powder, either raw or pre-washed, is mixed with the carbon precursor, preferably in the form of resin, preferably phenolic resin, dissolved in IPA. The required amount of carbon precursor depends on the carbon yield upon pyrolysis, where carbon contents should be 5-8 mass %. For example, 18 kg phenolic resin may be added per 100 kg boron carbide. In both cases the mixture is dried and granulated. If a polysaccharide aqueous solution is chosen as the carbon precursor, the preferred drying method is by spray drying. The step of mixing with the carbon precursor may follow the above step of pre-washing or may be performed simultaneously with it. The dried blend, the solvent being between 0 and 4%, is granulated and sieved to at least 20 mesh, preferably to 40 or 45 mesh.

### Compacting the Powder Blend

The compaction under elevated temperature results in a viscous flow of the carbon precursor along with the ceramic particles. The viscous flow enables compaction of non-flat (curved-shape) objects, where leveling of the pre-compacted powder, which is essential for obtaining uniform and homogeneous green object, is not possible. Compaction pressures may be, for example, between 500 and 1000 kg/cm², temperatures between room temperature and up to 165-210° C. The compaction times will depend on the size of the compacted object, and may be for example between 15 seconds and 5 minutes.

### Carbonizing the Compacted Green Object

Heating in an inert atmosphere (e.g., stream of nitrogen) of the compacted boron-carbide and carbon precursor blend is carried out at a high temperature in order to convert the precursor to carbon. The process is carried out in a controlled schedule because the gaseous products are to be evacuated from the compact object in a sufficiently slow rate in order not to cause their cracking, typically—but not limitatively—during 3 to 5 hours. The term “high temperature” refers to temperatures which are typically in the range 550° C.-1050° C., preferably higher than 500° C.

### Sintering

The green, carbonized objects are heated in an inert atmosphere (argon) in a controlled heating schedule, and soaked in high temperature (approx. 2300° C.). Surface and bulk diffusion processes result in densification and volume shrinkage of the objects. The carbon additive acts in a two-fold role: It reduces oxide compounds which hinder the sintering process, and it also inhibits grain growth at the sintering temperature. The temperature increase may occur, for example, between 3 and 5 hours, holding the object at the maximal temperature takes between 10 and 240 minutes, preferably at least 20 minutes, usually between 20 and 120 minutes, and the phase of temperature decrease may last about 3 hours, the temperature change velocity may be between 100 and 300 deg/hr. The maximal temperature is preferably between 2300° C. and 2350° C.

The product has preferably a density of at least 93.5%, more preferably at least 94.0%, such as at least 94.5% or at least 95.0% or at least 95.5% or at least 96.0,

### EXAMPLES

The aforesaid and other characteristics and advantages of the invention will be better understood through the description of the following illustrative and non-limitative examples.

In all experiments the boron carbide powder having following characteristics has been used:
B.E.T. area: 2.2 m²/gr
D₅₀≦5.8 μm, D₉₀≦10 μm
Boron to carbon ratio: 3.9-4.1
Contents of free carbon: 1.2% (mass)
Total contents of boron and carbon: 97% (mass)
Remaining contents of B₂O₃:0.35% (mass)

### Experimental Setup

1. Mixing was done with either ball-milling machine (in plastic container) or laboratory mixer.
2. Drying of IPA containing blends (after pre-wash stage or after mixing with phenolic resin) was carried out in a water jacket incubator (Shel Lab, model 3025). This kind of oven has water filled double-walls. Heating elements, located in the double-wall gaps, are utilized to control the water temperature which governs the chamber temperature. This kind of oven is required due to safety reasons, in order to avoid contact between the IPA vapors and the heating elements, which may result in explosion danger.
3. Spray drying was carried out in a Niro No.1 Bowen tower (by Bowen Engineering, Columbia, Md., U.S.A.). Spraying parameters where as follows: Air inlet temperature—280° C., outlet temperature—140° C., atomizing air pressure—3.5 bar.
4. Carbonization was performed in a retort type furnace (Lindberg, model 51662-R), equipped with Nitrogen inlet and outlet tubes. Nitrogen flow rate (1 lit/min.) control was performed via rotameter.
5. The sintering furnace was a cylindrical-bottom loading type (by Centorr-Vacuum Industries, model 9x12-G-D6A3-A-25).

### Example 1

Phenolic resin (Durit SC1008, by Borden Inc., Columbus, Ohio, U.S.A.) was diluted by IPA, at mixing ratio of 125 (gr. resin) : 1000 (cc IPA) to obtain a homogeneous solution. Boron carbide powder having particle size D₅₀=5.8 μm, D₉₀=10 μm and specific area (B.E.T.) 2.2 m²/gr was gradually added to the resin solution. Raw resin/powder ratio was 15:100 (mass). The blend was mixed for 24 hrs, oven dried at 70° C. and the dried cake was granulated using a 20 mesh size sieve. A finer sieve can also be used.

The granulated powder was cold pressed (80 MPa) in a 59×59 mm mold to form flat green square-shaped objects having density of 1.36 to 1.60 g/cc. Further these objects were carbonized in a stream of nitrogen (1 lit/min). The heating schedule was as follows: heating at the rate 25° C./hr up to 550° C., further heating at the rate 100° C./hr up to 1000° C., soaking for 5 hrs., furnace cooling to room temperature. When this stage completed the carbonized green objects contained 5.4% of amorphous carbon. At the next stage the carbonized green objects were sintered in the stream of argon, utilizing the electrical resistance furnace having graphite elements and insulation. The heating schedule was as follows: double vacuum purge prior to heating in order to eliminate oxygen residues, Argon flow, heating to 1800° C. at the rate 900° C./hr, heating up to 2100° C. at the rate 300° C./hr, heating up to 2330° C. at the rate 150° C./hr, soaking for 30 min, cooling at the rate 600° C./hr to approximately 1000° C. and then furnace cooling to room temperature.

The sintered objects has undergone 18% linear shrinkage upon sintering, and had a density of 2.3 g/cc, corresponding to 92.9% TD.

### Example 2

Operating similarly to the procedure of Example 1, but with the difference that the stage of pre-washing was conducted in the following way: the boron carbide powder was mixed with IPA for 24 hours (mixing ratio 0.75 Kg powder/1 liter IPA). Then the mixture was dried in the oven at 70° C. and further processed according to Example 1 to form sintered boron carbide objects.

The final product had a density of 2.38 g/cc, corresponding to 94.4% TD.

### Example 3

Operating similarly to Example 2, but with the difference that the pre-washing was carried out in methanol, the boron carbide powder was mixed with methanol for 24 hours (mixing ratio 0.75 Kg powder/1 liter methanol). Then the mixture was dried in the oven at 70° C. and further processed according to Example 1 to form sintered boron carbide objects.

The final product had a density of 2.376 g/cc, corresponding to 94.3% TD.

### Example 4

### (Comparative)

Operating similarly to Example 1, but with the difference that boron carbide powder had a smaller particle size, namely D₅₀=4.6 μm, D₉₀=9.2 μm and specific area (B.E.T.) 2.49 m²/gr.

The final product had a density of 2.38 gr/cc, corresponding to 94.4% TD.

### Example 5

Operating similarly to Example 4, but with the difference that pre-washed boron carbide powder was mixed with IPA as described in Example 2. The heating rate during the carbonization stage was 100° C./hr.

The final product had a density of 2.42 gr/cc, corresponding to 96% TD.

### Example 6

### (Comparative)

Operating similarly to Example 4, but with the difference that compaction process was carried out while the mold was heated to 160° C. The granulated powder was poured into the mold cavity, and then the pressure was applied for 10 minutes.

The final product had a density of 2.40 gr/cc, corresponding to 95.2% TD.

### Example 7

Operating similarly to Example 6, but with the difference that pre-washed boron carbide powder was mixed with IPA as described in Example 2.

The final product had a density of 2.43 g/cc, corresponding to 96.4% TD.

### Example 8

### (Comparative)

Operating similarly to Example 6, but with the difference that compaction process was conducted in a spherical dome shaped mold. The dome inner spherical radius was 242 mm, the dome outer spherical radius was 247.5 mm, and basal diameter of the dome was 105 mm. The granulated powder was poured into the mold cavity and pressure was applied while the powder was not leveled. The phenolic resin has undergone a viscous flow along with the ceramic particles to fill the mold cavity between the dies and to form a uniform green compact.

The domes were sintered between top and bottom graphite dies, each one machined to match the outer and inner sphere radius, respectively. While sintering without the shaped graphite dies the domes have undergone a severe geometrical distortion, due to free sagging while being at the high sintering temperature. The sintered domes had a density of 2.395 g/cc, corresponding to 95% TD. While the spherical radii remained unchanged, both the dome basal diameter and the thickness have undergone 18% shrinkage.

Example 9

Operating similarly to Example 8, but with the difference that pre-washed boron carbide powder was mixed with IPA as described in Example 2.

The sintered domes had a density of 2.434 g/cc, corresponding to 96.6% TD.

Example 10

### (Comparative)

An aqueous solution of 230 gr maltodextrin (dextrose equivalent, DE=15), 10 gr PVA (polyvinyl alcohol) and 1000 gr water were mixed with 1000 gr boron carbide powder having the same properties as in Example 4.

After that the slurry was spray-dried. A free flowing spherical granulated powder was obtained. The powder was then hot compacted in a 59×59 mm mold, while the mold was heated to 130° C. The compacting pressure 80 MPa, was applied for 10 minutes. Uniform high strength green objects were obtained. The green objects were pyrolyzed in a nitrogen stream in order to convert the maltodextrin to carbon. The heating schedule was as follows: heating at the rate 25° C./hr to 650° C., soaking for 5 hours, furnace cooling to room temperature. Sintering was carried out according to Example 1.

The final product density was 2.395 g/cc, corresponding to 95.1% TD.

### Example 11

Operating similarly to Example 10, but with the difference that a pre-washed boron carbide powder had the same properties as in Example 4.

The final product density was 2.425 g/cc, corresponding to 96.2% TD.

Example 12

Operating similarly to Example 11, but with the difference that the objects had a shape of a spherical dome as described in Examples 8 and 9. During pressing, maltodextrin has undergone a viscous flow along with the ceramic particles to fill the mold cavity between the dies and to form a uniform, high strength green compact object. Carbonizing and sintering were conducted in the same mode as in Example 10.

The final product had a density of 2.43 g/cc, corresponding to 96.4% TD.

Example 13

Ballistic tests, developed for this purpose, included placing a ceramic tile product onto a thick aluminum layer, and measuring the residual penetration of a bullet shot into the tile and passing into the layer. The tests showed increased strength in the product of Example 2 compared to 1, Example 5 compared to 4, Example 7 compared to 6, Example 9 compared to 8, and Example 11 compared to 10.

What is claimed is:

1. A process for manufacturing boron carbide objects comprising the steps of:
(a) pre-washing a raw boron carbide powder with an organic solvent selected from the group consisting of isopropyl alcohol, ethyl alcohol, methyl alcohol, acetone, and a combination thereof, said pre-washing including stirring a mixture comprising said powder with said solvent for about 24 hours, followed by removing a substantial part of said solvent from said mixture;
(b) mixing a boron carbide powder with a carbon precursor selected from the group consisting of phenolic resin, aqueous solution of a polysaccharide, and mixture of two or more saccharides;
(c) drying and granulating a boron carbide, pre-washed and mixed with a carbon precursor according to steps (a) and (b);
(d) compacting the granulated dried mixture of step (c) to form a shaped object by applying a pressure thereto;
(e) carbonizing the shaped body in an inert atmosphere, by dwelling at a high temperature for a predetermined period of time; and
(f) sintering the carbonized shaped body at a temperature between about 2300° C. and about 2350° C. in an inert atmosphere for a time period of not less than about 20 min.

2. The process of claim 1, wherein said steps (a) and (b) are carried out simultaneously.

3. The process of claim 1, wherein the carbon precursor which is mixed with the boron carbide powder includes a phenolic resin.

4. The process according to claim 1, wherein the drying is carried out by spray drying.

5. The process of claim 1, wherein the pressure is applied uniaxially.

6. The process of claim 1, wherein the pressure is applied isostatically.

7. The process of claim 1, wherein the compacting is carried out with heating.

8. The process of claim 7, wherein the compaction is carried out at a temperature of between about 130° C. and about 170° C.

9. The process of claim 1, wherein compaction is carried out until the density of the compacted shaped body reaches a value of at least 1.36 g/cc.

10. The process of claim 1, wherein the carbonization step is carried out in a nitrogen atmosphere.

11. The process of claim 1, wherein the carbonization step is carried out in an argon atmosphere.

12. The process of claim 1, wherein the sintering is carried out in an argon atmosphere.

13. The process of claim 1, wherein the sintering is performed while the shaped body is constrained between shaped graphite dies having essentially a geometry to match a desired final geometry of said shaped body.

14. The process of claim 13, wherein the graphite dies have a non-flat, multi-curved shape.

15. A robust process for manufacturing boron carbide objects of superior anti-ballistic performance from a low grade boron carbide powder, employing pressureless sintering, comprising:
(a) providing a low grade raw boron carbide powder having a BET surface area as low as about 4 m²/g or D₅₀ value as high as 5 μm;
(b) pre-washing said low grade powder with an organic solvent selected from the group consisting of isopropyl alcohol, ethyl alcohol, methyl alcohol, acetone, and a combination thereof, said pre-washing including stifling a mixture comprising said powder with said solvent for about 24 hours, followed by removing a substantial part of said solvent from said mixture;
(c) mixing said low grade powder, either after pre-washing of step (b) or simultaneously therewith, with a carbon precursor selected from the group consisting of phenolic resin, aqueous solution of a polysaccharide, and mixture of two or more saccharides;
(d) drying and granulating a boron carbide, pre-washed and mixed with a carbon precursor according to steps (b) and (c);
(e) compacting the granulated dried mixture of step (d) to form a shaped object by applying a pressure thereto;
(f) carbonizing the shaped body in an inert atmosphere, by dwelling at a high temperature for a predetermined period of time; and
(g) sintering the carbonized shaped body at a temperature between about 2300° C. and about 2350° C. in an inert atmosphere for a time period of not less than about 20 min.

16. The robust process for manufacturing boron carbide objects of superior anti-ballistic performance from a low grade boron carbide powder according to claim 15, employing pressureless sintering, consisting of the following steps:
(a) providing a low grade raw boron carbide powder having a BET surface area as low as about 2 m²/g;
(b) pre-washing said low grade powder with isopropyl alcohol (IPA), said pre-washing including stirring a mixture at least 0.66 kg of IPA per 1 kg of said powder for about 24 hours;
(c) mixing said low grade powder, either after pre-washing of step (b) or simultaneously therewith, with a carbon precursor comprising phenolic resin in an amount of about 0.15 to about 0.18 kg per 1 kg of said powder;
(d) drying and granulating a boron carbide, pre-washed and mixed with said carbon precursor according to steps (b) and (c);
(e) compacting the granulated dried mixture of step (d) to form a shaped object by applying a pressure thereto;
(f) carbonizing the shaped body in an inert atmosphere, by dwelling at a temperature between about 500° C. and about 1000° C. for a predetermined period of time; and
(g) sintering the carbonized shaped body at a temperature between 2300° C. and 2350° C. in an argon atmosphere for a time period of between 30 and 60 min.

17. Shaped, high-density boron carbide antiballistic objects made by a process for manufacturing boron carbide objects comprising the steps of:
(a) pre-washing a raw boron carbide powder with an organic solvent selected from the group consisting of isopropyl alcohol, ethyl alcohol, methyl alcohol, acetone, and a combination thereof, said pre-washing including stifling a mixture comprising said powder with said solvent for about 24 hours, followed by removing a substantial part of said solvent from said mixture;
(b) mixing a boron carbide powder with a carbon precursor selected from the group consisting of phenolic resin, aqueous solution of a polysaccharide, and mixture of two or more saccharides;
(c) drying and granulating a boron carbide, pre-washed and mixed with a carbon precursor according to steps (a) and (b);
(d) compacting the granulated dried mixture of step (c) to form a shaped object by applying a pressure thereto;
(e) carbonizing the shaped body in an inert atmosphere, by dwelling at a high temperature for a predetermined period of time; and
(f) sintering the carbonized shaped body at a temperature between about 2300° C. and about 2350° C. in an inert atmosphere for a time period of not less than about 20 min.
